(19) United States
(12) Patent Application Publication
(10) Pub. No.: US 2008/0070524 A1
(43) Pub. Date: Mar. 20, 2008

(54) Slidable blue tooth earphone device

(76) Inventors: Yu-Chang Cheng, Sindian City (TW); Chen-Yi Hsiao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/521,399

(22) Filed: Sep. 15, 2006

(51) Int. Cl. H04B 1/18

(52) U.S. Cl. 455/187.1

(57) ABSTRACT

A slidable blue tooth earphone device is shown below. By pressing a button to push an oscillating stick, the oscillating stick is rotated. A first retaining portion of a body is detached from a second retaining portion of a slidable element to let a resilient element push the slidable element to make it movie. Via a damping gear meshed with a rack of the slidable element and a guiding track of the slidable element sliding on a guiding channel of a side plate, the slidable element moves forward stably. Thereby, the slidable element moves forward stably and arrives to a predetermined position speedily. Furthermore, due to this design of the blue tooth device will not be easily detached.

### BACKGROUND OF THE INVENTION

1. Field of the Invention

The present invention relates to a slidable blue tooth earphone device, and particularly relates to a slidable blue tooth earphone device that can provide a suitable distance between the user's mouth and the microphone by sliding the rest of the microphone.

2. Background of the Invention

A conventional earpiece structure is disclosed in Taiwan patent no. 540946, publication date: Jul. 1, 2003, which title is “suspensible headset earphone structure with adjustable length of voice reception portion”. The suspensible headset earphone structure includes a voice broadcast portion having a loudspeaker received therein. The loudspeaker connects to a cord extending outwardly from the voice broadcast portion. An end of the cord can connect with an electronic device. Furthermore, the voice broadcast portion has a projection disposed on an exterior portion and a clamping portion arranged on the projection. The suspensible headset earphone structure further includes an elongation portion and an earpiece. The elongation portion is hollow. The elongation portion has an end pivoted to the voice broadcast portion, and a switch arranged on backside of the end for controlling the power of the earphone. The earpiece is arc-curved and auricle-shaped. The earpiece has an end fitting the clamping portion of the projection of the voice broadcast portion, and an opposite end hooking along the outline of user's ear. Therefore, the voice broadcast portion attaches to the ear. The suspensible headset earphone structure is characterized by: the elongation portion has a voice reception portion of adjustable length, sleeved on an opposite end thereof. The voice reception portion includes a microphone extending into the voice broadcast portion to connect a cord thereof so as to receive user's voice.

However, the length of the voice reception portion of the conventional earphone structure mentioned above should be adjusted by manual, and it will make the earpiece loose from user's ear. Repeating hooks the earphone on the ear is very inconvenient for users.

Hence, an improvement over the prior art is required to overcome the disadvantages thereof.

### SUMMARY OF THE INVENTION

The primary object of the invention is therefore to specify a slidable blue tooth earphone device is shown below. By pressing a button to push an oscillating stick, the oscillating stick is rotated. A first retaining portion of a body is detached from a second retaining portion of a slidable element to let a resilient element push the slidable element to make it movie. Via a damping gear meshed with a rack of the slidable element and a guiding track of the slidable element sliding on a guiding channel of a side plate, the slidable element moves forward stably. Thereby, the slidable element moves forward stably and arrives to a predetermined position speedily. Furthermore, due to this design of the blue tooth device will not be easily detached.

According to the invention, the object is achieved by a slidable blue tooth earphone device is shown below. The slidable blue tooth earphone device includes a body, a button, at least one side plate, a slidable member, a push assembly and an orientation assembly. The body has a reception cavity formed thereof, and a loudspeaker and an electrical circuit board arranged in the reception cavity; wherein the loudspeaker electrically connects with the printed circuit board. The button is disposed on the body. The side of the body arranges the side plate. The slidable member is skidding on the body and has a microphone secured therein, wherein the microphone electrically connects with the printed circuit board. The push assembly includes at least one damping gear, at least one resilient member and at least one rack; wherein the damping gear and the resilient member are disposed in the reception cavity, the rack is arranged on the slidable member, the damping gear meshes with the rack, and the resilient member propping against the slidable member. The orientation assembly includes at least one oscillating stick, at least one first retaining portion and at least one second retaining portion, wherein the oscillating stick pivots to the body, the button and the slidable member retain against the oscillating stick, which is frozen without free sway, the first retaining portion is disposed on the body, the second retaining portion is arranged on the slidable member, and the first retaining portion engaged with the second one.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a slidable blue tooth earphone device according to the present invention;

FIG. 2 is a decomposition view of the slidable blue tooth earphone device according to the present invention;

FIG. 3 is a perspective view to show a push assembly according to the present invention;

FIG. 4A is a perspective view illustrating a first embodiment of the slidable blue tooth earphone device according to the present invention; and

FIG. 4B is a perspective view illustrating a second embodiment of the slidable blue tooth earphone device according to the present invention.

### DETAILED DESCRIPTION OF THE EMBODIMENTS

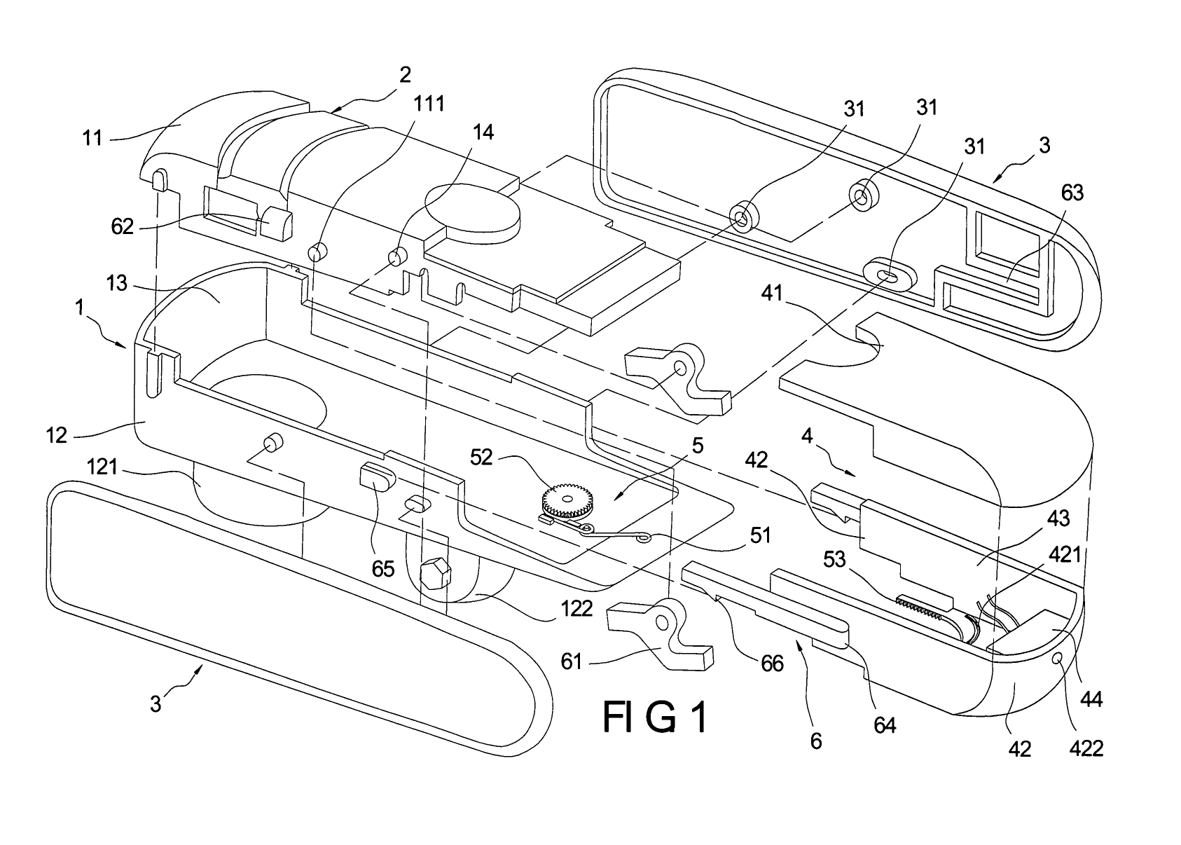

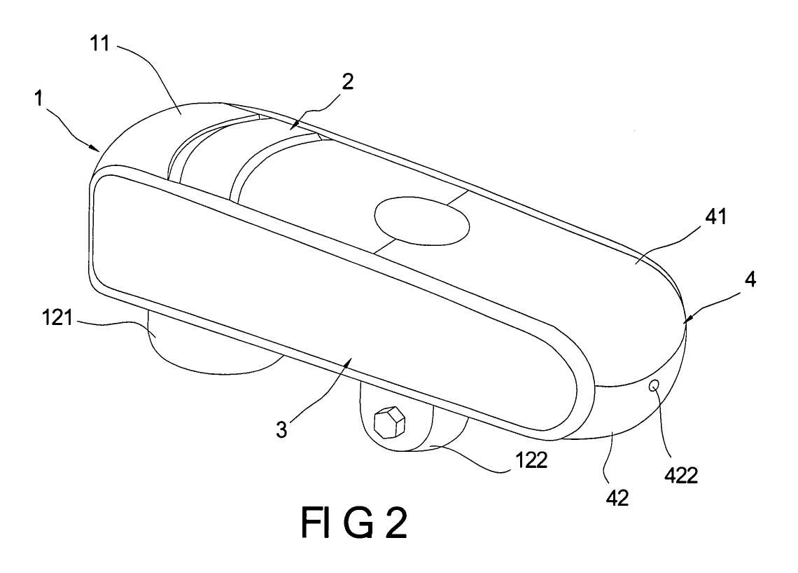

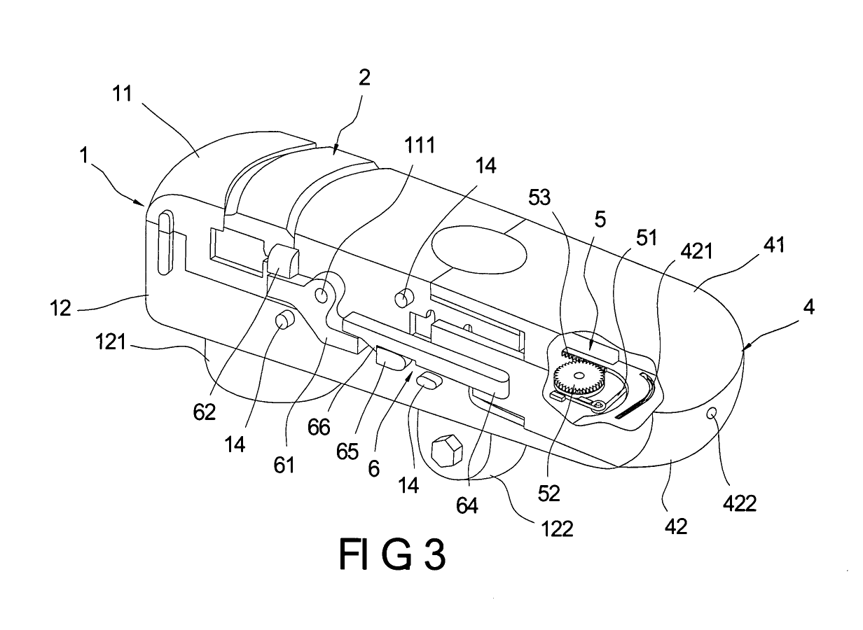

Referring to FIGS. 1, 2, 3 and 4A, a slidable blue tooth earphone device of the present invention includes a body 1, a button 2, two side plates 3, a slidable member 4, a push assembly 5 and an orientation assembly 6.

The body 1 is hollow and has an upper cover 11 and a lower cover 12 attached to each other. The body 1 further has a first reception cavity 13, communicating with a front opening, formed at a front end thereof, and a loudspeaker (not shown) and a electrical circuit board (not shown) arranged in the first reception cavity 1. The loudspeaker electrically connects with the printed circuit board. The body 1 has a voice broadcast portion 121 and a connection portion 122 arranged under the lower cover 12. The loudspeaker locates in the voice broadcast portion 121, which can attach to user's ear (not shown) for transmitting sound information. The connection portion 122 joins with an earhang (not shown) for hooking the earphone device on the user's ear. In addition, the body 1 includes a plurality of fastening blocks 14 arranged laterally, in order to secure the two side plates 3 thereto. The body 1 has two pillars 111 projecting from two lateral sides thereof. Due to the pillars 111, the orientation assembly 6 can be pivoted to the upper cover 11 of the body 1.

The button 2 is arranged on a top of the upper cover 11. The button can moves forwards and backwards in the first reception cavity 13, so that the orientation assembly 6 can be pushed to force the slidable member 4 forwardly via the push assembly 5.

The two side plates 3 are lengthy, and each has a plurality of fastening slots 31 formed in an inner surface thereof for fixed to the fastening blocks 14 of the body 1 by supersonic bonding manner. Thus, the two side plates 3 are secured at two lateral sides of the body 1.

The slidable member 4 is hollow and glidingly formed at the front opening of the body 1. The slidable member 4 has a slidable upper cover 41 and a slidable lower cover 42 attached to each other. The slidable member 4 further has a second reception cavity 43, communicating with a rear opening, formed at a rear end thereof. The slidable member 4 includes a microphone 44 arranged in the second reception cavity 43 and secured to the slidable lower cover 42, wherein the microphone 44 electrically connects with the printed circuit board and is used for receiving user's voice. The slidable lower cover 42 further has a sustaining portion 421 disposed at an indentation of a bottom thereof. The push assembly 5 abuts against the sustaining portion 421, and the slidable member 4 is forced forwardly thereby. The slidable member 4 has a voice aperture 422 penetrating through a front end of the slidable upper cover 41 for increase the reception effect of the microphone 4. When the slidable member 4 moves, the switch (not shown) of the printed circuit board can be triggered or not to control the power of the earphone device.

The push assembly 5 includes a resilient member 51, a damping gear 52, and a rack 53. The resilient member 51 is a torsion spring. The damping gear and the resilient member are disposed in the first reception cavity 13 and secured to the lower cover 12. The resilient member 51 props against the sustaining portion 421 of the slidable lower cover 42 of the slidable member 4, so that the slidable member 4 moves forwardly. The rack 53 is arranged under the slidable lower cover 42 of the slidable member 4 integrally in one piece. The rack 53 can mesh with the damping gear 52, so that the slidable member 4 can move forwardly at a stable speed.

The orientation assembly 6 includes two oscillating sticks 61, two pressing block 62, two guiding channels 63, two guiding tracks 64, two first retaining portions 65 and two second retaining portions 66. The oscillating sticks 61 pivots to the upper cover 11 of the body 1 via the pillars 111. The two pressing blocks 62 are disposed at two lateral sides of the button 2 integrally in one piece. The button 2 retains against an end of each oscillating stick 61 via each pressing block 62. The two guiding channels 63 are formed inside the two side plates 3. The two guiding tracks 64 are formed at two exterior sides of the slidable lower cover 42 integrally in one piece. Therefore, the two guiding tracks 64 glidingly arranged on the two guiding channels 63 respectively, and the slidable member 4 can forward moves stably for position. Each of the guiding tracks 64 has a free end extending forward and against each oscillating stick 61, which is frozen without free sway via each pressing block 62 and guiding track 64.

The two second retaining portions 65 are disposed at two lateral exterior sides of the lower cover 12. The two second retaining portions 66 are made on the two guiding tracks 64 respectively and integrally in one piece. Each second retaining portion 66 closes to a free end of each guiding track 64. The two second retaining portions 66 project downwardly, and can engage with the first retaining portions 65 respectively. The second retaining portions 66 are arranged between the first retaining portions 65 and the oscillating sticks 61 respectively to stop the slidable member 4 moving on.

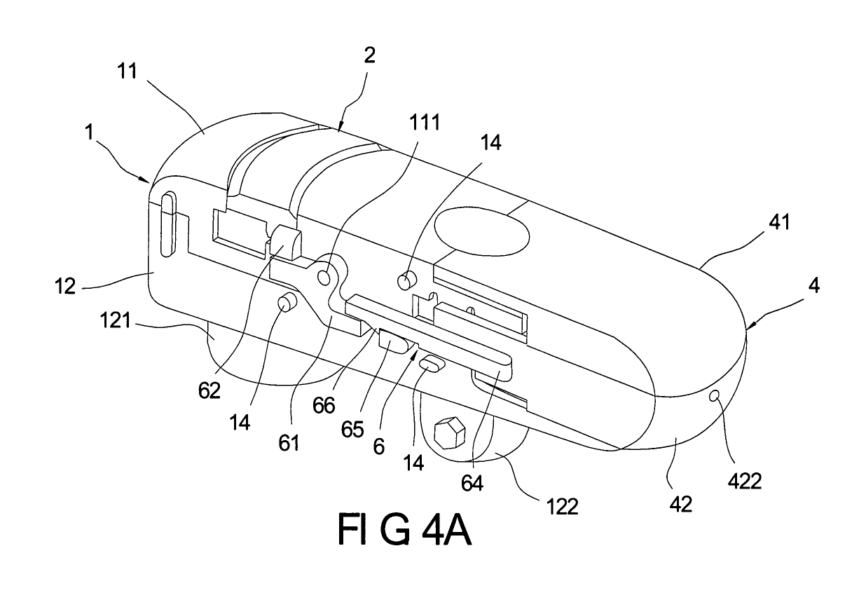

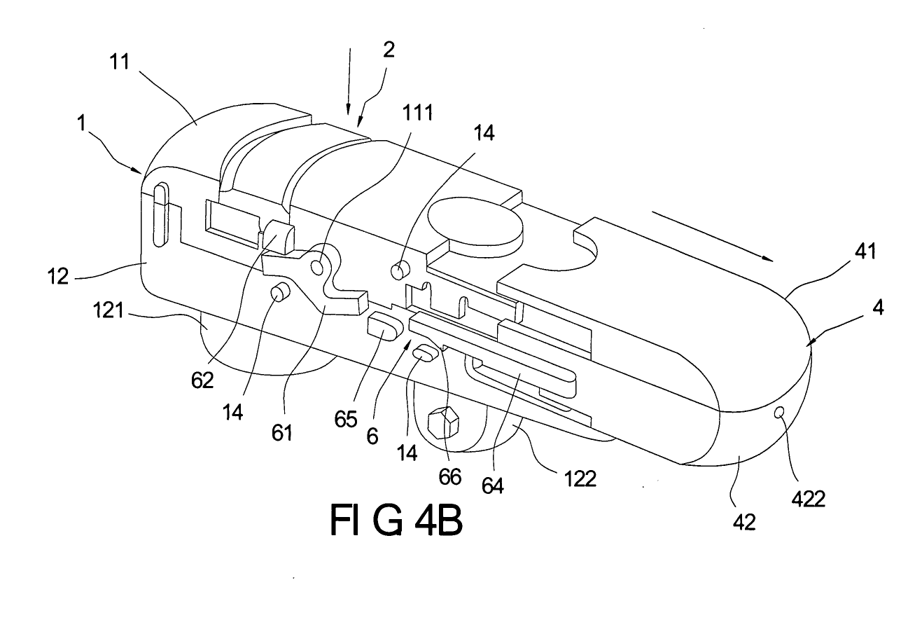

When the earphone device is in use, the user can hook the earhang on the ear, and let the voice broadcast portion 121 attach to the ear. Then, the button 2 can be pressed to force the two pressing blocks 62, the two pressing blocks 62 two compel against the two oscillating sticks 61 respectively, the oscillating sticks 61 swing to lift the free ends of the guiding tracks 64 respectively, and the two second retaining portions 66 can detach from the first retaining portions 65 respectively (shown in FIG. 4B). The guiding member 4 can slide due to the pressure form the resilient member 51 of the push assembly 5, then the two guiding tracks 64 respectively move forward in the guiding channels 63 and the rack 53 drives the damping gear 52. Thus, the power of the earphone device is on, the voice broadcast portion 121 and the microphone 44 works.

While the slidable member 4 should be returned to original position by manual, the free ends of the two guiding tracks 64 respectively abut against the two oscillating sticks 61 and the two second retaining portions 66 respectively engage with the first ones 65. Therefore, the slidable member 4 cannot move anymore and the power of the earphone device shuts down.

The slidable blue tooth earphone device, according to the present invention, is characterized by: pressing the button 2 to push the oscillating sticks 61 to rotate. The first retaining portion 65 is detached from the second retaining portion 66 to let the resilient element 51 push the slidable element 4 to make it movie. The two guiding tracks 64 move and slide in the guiding channels 63, and the rack 53 drive the damping gear 52. Thereby, the slidable element 4 moves forward stably and arrives to a predetermined position speedily. Furthermore, due to this design of the blue tooth device will not be easily detached.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A slidable blue tooth earphone device comprising:
a body having a reception cavity formed at a inner portion thereof, and a loudspeaker and a electrical circuit board arranged in the reception cavity;
wherein the loudspeaker electrically connects with the printed circuit board;
a button disposed on the body;
at least one side plate arranged by the body;
a slidable member slidably disposed on the body and having a microphone secured therein, wherein the microphone electrically connects with the printed circuit board;
a push assembly including at least one damping gear, at least one resilient member and at least one rack; wherein the damping gear and the resilient member are disposed in the reception cavity, the rack is arranged on the slidable member, the damping gear meshes with the rack, and the resilient member propping against the slidable member; and
an orientation assembly including at least one oscillating stick, at least one first retaining portion and at least one second retaining portion, wherein the oscillating stick pivots to the body, the button and the slidable member retain against the oscillating stick, which is frozen without free sway, the first retaining portion is disposed on the body, the second retaining portion is arranged on the slidable member, and the first retaining portion engaged with the second one.

2. The slidable blue tooth earphone device as claimed in claim 1, wherein the body has an upper cover and a lower cover attached to each other, the damping gear and the resilient member are arranged in the reception cavity and secured to the lower cover.

3. The slidable blue tooth earphone device as claimed in claim 2, wherein the lower cover has a voice broadcast portion, where the loudspeaker locates.

4. The slidable blue tooth earphone device as claimed in claim 2, wherein the lower cover has a connection portion, which joins with an earhang.

5. The slidable blue tooth earphone device as claimed in claim 1, wherein the body has at least one pillar projecting from the body; due to the pillar, the oscillating stick is pivoted to the body.

6. The slidable blue tooth earphone device as claimed in claim 1, wherein the body includes a plurality of fastening blocks, and the side plate has a plurality of fastening slots fixed to the fastening blocks of the body.

7. The slidable blue tooth earphone device as claimed in claim 1, wherein slidable member has a slidable upper cover and a slidable lower cover attached to each other, the rack is arranged on the slidable lower cover, and the slidable lower cover further has a sustaining portion against which the resilient member pushes.

8. The slidable blue tooth earphone device as claimed in claim 1, wherein the orientation assembly includes at least one guiding channel formed on the side plate and at least one guiding track arranged on the slidable member, so that the guiding track is slide-arranged on the guiding channel and the second retaining portion is disposed on the guiding track.

9. The slidable blue tooth earphone device as claimed in claim 8, wherein the guiding track is made integrally with the slidable member in one piece, the guiding track has a free end extending forward and against the oscillating stick.

10. The slidable blue tooth earphone device as claimed in claim 1, wherein the orientation assembly has a pressing block connected to the button so that the button abuts against the oscillating stick.

11. The slidable blue tooth earphone device as claimed in claim 1, wherein the second retaining portion is arranged between the first retaining portion and the oscillating stick.

12. The slidable blue tooth earphone device as claimed in claim 1, wherein the slidable member has a voice aperture.
